(19) United States
(12) Patent Application Publication
(10) Pub. No.: US 2009/0095669 A1
(43) Pub. Date: Apr. 16, 2009

(54) Filter with inverted threads

(75) Inventor: Kevin C. South, Cookeville, TN (US)

Correspondence Address: KRIEG DEVAULT LLP, ONE INDIANA SQUARE, SUITE 2800, INDIANAPOLIS, IN, 46204-2079, US

(73) Assignee: Cummins Filtration IP, Inc.

(21) Appl. No.: 11/974,667

(22) Filed: Oct. 15, 2007

(51) Int. Cl. B01D 35/30; B01D 27/08

(52) U.S. Cl. 210/232; 210/444

(57) ABSTRACT

A replaceable cartridge for use with a filter housing having a substantially closed dome end and a head end. The cartridge comprises a filter media connected to and extending between a head end endplate and a dome end endplate. The dome end endplate includes means for mating with the filter housing. The filter housing comprises a canister extending between a substantially open head end and a substantially closed dome end. The canister has an interior surface that includes corresponding means for engaging the filter cartridge. The means for engaging the cartridge is positioned substantially adjacent the dome end.

### BACKGROUND

The present invention relates generally to a filter unit and/or filter housing which can be used, for example, with internal combustion engines, such as diesel or gasoline powered engines. Such filter units are utilized since various fluids used in vehicle engines are susceptible to being contaminated by water, sand, dirt and other particulate materials.

Large amounts of vibration can cause water and/or particle re-entrainment back into the fluid being filtered. Further, the compensation for large amounts of vibration can result in the over design of the thickness of the shell of a filter housing, as well as the thickness of the nutplate of housings that include a nutplate.

Accordingly there is a need for a unique and inventive apparatus of a filter cartridge and/or filter housing according to the present invention.

### SUMMARY

In one embodiment of the present invention there is an apparatus comprising a filter cartridge and a filter housing. The filter cartridge comprises a filter media connected to and extending between a dome end endplate and a head end endplate. The filter housing comprises a canister extending between a substantially open head end and a substantially closed dome end. The canister has an interior surface that includes means for engaging the filter cartridge. The means for engaging the cartridge is positioned substantially adjacent the dome end. The dome end endplate includes means for mating to the housing to secure the dome end endplate to the housing substantially adjacent to the dome end of the housing.

In one refinement of the present invention the means for engaging the cartridge comprises threading.

In another refinement of the present invention the threading is adjacent the dome end of the housing.

In another refinement of the present invention the threading is internal threading.

In another refinement of the present invention the means for mating to the housing is external threading extending around at least a portion of a perimeter of the dome end endplate of the cartridge.

In another refinement of the present invention the means for mating to the housing comprises a plurality of pins extending from the dome end endplate of the cartridge, and the means for engaging the cartridge comprises a plurality of openings that receive the pins of the cartridge.

In another refinement of the present invention the apparatus is a centrifugal filter. The means for engaging the cartridge and the means for mating to the housing are positioned substantially adjacent to a point of the largest amplitude vibration of the apparatus.

In another refinement of the present invention the canister has an external surface that defines external threading substantially adjacent to the head end.

In another refinement of the present invention the head end endplate defines an inlet opening for an unfiltered fluid.

In another refinement of the present invention the cartridge further includes a substantially hollow member with a sidewall extending from an open first end connected to the inlet opening toward a closed second end. The closed second end of the member is closer to the dome end endplate than the head end endplate. The sidewall of the member defines a plurality of openings between the first end and the second end.

In another refinement of the present invention the head end endplate includes a radially outermost portion that extends axially toward the dome end endplate and overlaps a portion of the filter media.

In another refinement of the present invention the head end endplate includes a radially outermost portion that defines a plurality of outlet openings.

In another embodiment of the present invention there is a replaceable cartridge for use with a filter housing having a substantially closed dome end and a head end. The cartridge comprises a filter media connected to and extending between a head end endplate and a dome end endplate. The dome end endplate includes threading to secure the dome end endplate within the housing substantially adjacent to the dome end of the housing.

In another refinement of the present invention the head end endplate defines an inlet opening for an unfiltered fluid. The cartridge further includes a tube with a sidewall extending from an open first end connected to the inlet opening toward a closed second end. The second end of the tube is closer to the dome end endplate than the head end endplate. The sidewall defines a plurality of openings between the first end and the second end.

In another refinement of the present invention the head end endplate includes a radially outermost portion that extends axially toward the dome end endplate and overlaps a portion of the filter media. This radially outermost portion defines a plurality of outlet openings.

In another embodiment of the present invention there is a replaceable cartridge for use with a filter housing having a substantially closed dome end and a head end. The cartridge comprises a filter media connected to and extending between a head end endplate and a dome end endplate. The dome end endplate includes means for mating with the filter housing.

In one refinement of the present invention the means for mating to the housing is external threading extending around at least a portion of a perimeter of the dome end endplate of the cartridge.

In another refinement of the present invention the means for mating to the housing is a portion of a bayonet connection between the cartridge and the housing.

In another refinement of the present invention the head end endplate defines an inlet opening for an unfiltered fluid. The cartridge further includes a tube with a sidewall extending from an open first end connected to the inlet opening toward a closed second end. The second end of the tube is closer to the dome end endplate than the head end endplate. The sidewall defines a plurality of openings between the first end and the second end.

In another refinement of the present invention the head end endplate includes a radially outermost portion that extends axially toward the dome end endplate and overlaps a portion of the filter media. The radially outermost portion defines a plurality of outlet openings.

### BRIEF DESCRIPTION OF THE DRAWINGS

FIG. 1 is a side view of one embodiment of a filter cartridge of the present invention.

FIG. 2 is a perspective view of the embodiment of FIG. 1.

FIG. 3 is a top view of the embodiment of FIG. 1.

FIG. 4 is a side view of the combination of an embodiment of a filter housing and the filter cartridge of FIG. 1.

FIG. 5 is a cross-sectional view of the combination of an embodiment of a filter housing and the filter cartridge of FIG. 1.

### DESCRIPTION OF THE ILLUSTRATIVE EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

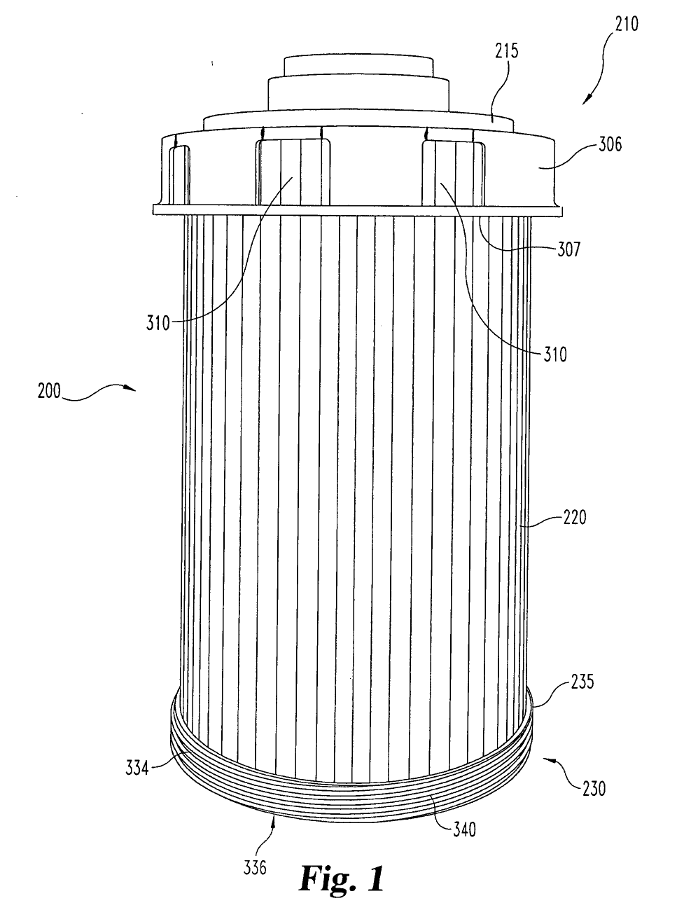

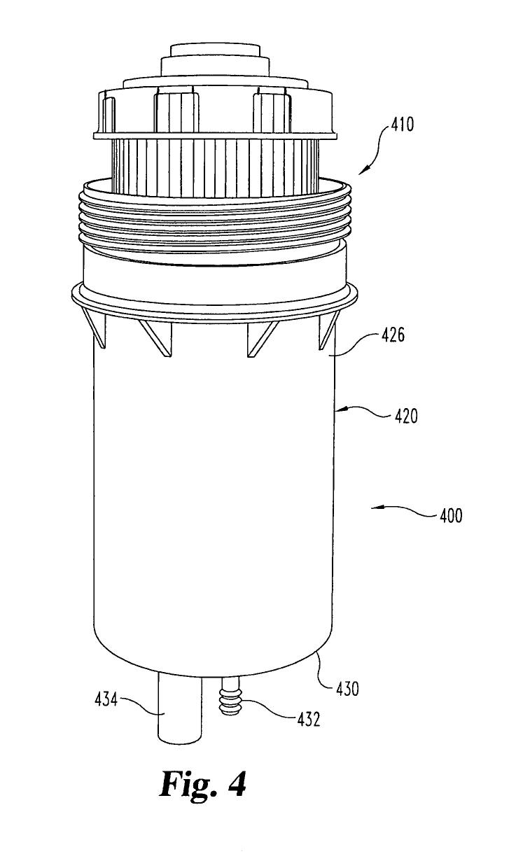

With reference to FIGS. 1-3, there are illustrated aspects of a filter cartridge 200 of one embodiment of the present invention. Filter cartridge 200 is preferably a replaceable filter cartridge. The cartridge 200 of the present invention has means for mating with a filter housing 400 (See FIG. 4). In some respects the filter housing 200 might preferably include some features typically present in a filter housing such as the Mach 2 filter housing of Cummins Filtration, the assignee of the present invention.

Filter cartridge 200 has filter media 220 extending between a head end 210 and a dome end 230. Filter media 220 is connected to head end endplate 215 and dome end endplate 235. One option for closing the media ends with the endplates is to embed the media directly into, for example, plastic endplates. This requires heating the endplates to soften the plastic. Another option is to bond the endplates to the ends of the media by a hot melt process or by the use of, for example, plastisol.

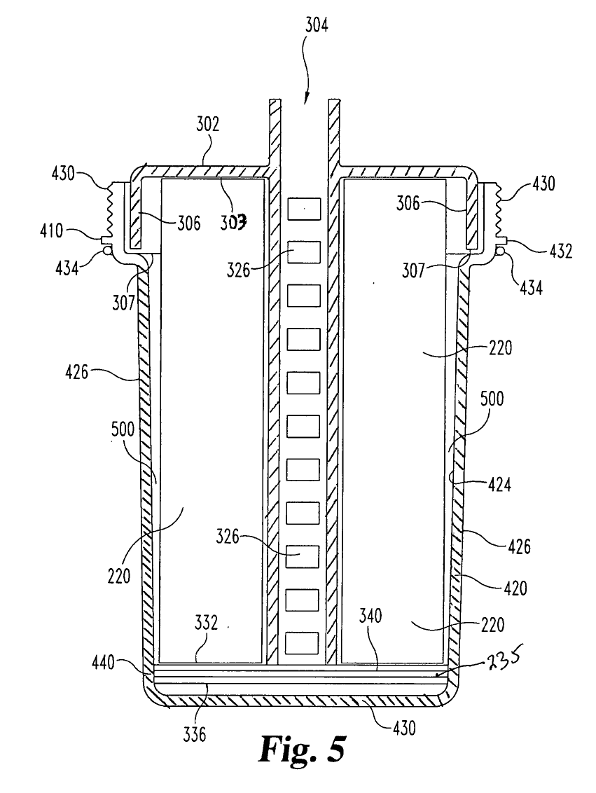

With continued references to FIGS. 1-3 there are illustrated various aspects concerning one embodiment of the head end endplate 215. The head end endplate 215 has a top surface 302 and a bottom surface 303 (See FIG. 5) to which the filter media 220 is connected. In one form the head end endplate 215 is substantially circular and includes a radially outermost portion 304. In a preferred form, head endplate 215 is circular and includes a radially outermost portion 304. In one embodiment the radially outermost portion 304 includes an axially extending portion 306. Portion 306 extends axially downward from the head end 210 toward the dome end 230 and overlaps a portion of the filter media 220. In one form, outermost portion 304 is intermittently present around the perimeter of the head end endplate 215 providing gaps 308. The intermittent presence of the radially outermost portion provides a flow path for filtered fluid to flow through on its path back to the engine. As illustrated, in some embodiments the radially outermost portion is only intermittent at top surface 302, but the perimeter of the end of the axially extending portion 306 is continuous at end 307. As illustrated, the gaps 308 are a part of larger outlet openings 310.

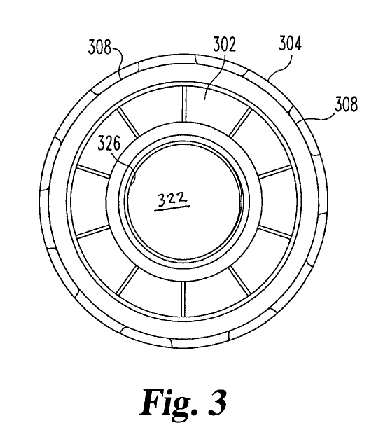

As illustrated in FIG. 3, head end endplate includes a preferably centrally located inlet opening 322 extending between the top surface 302 and the bottom surface 303. Inlet opening 322 provides a flow path for unfiltered fluid from the engine to flow into a substantially hollow tubular member 324. The preferably centrally positioned tube 324 includes a plurality of orifices 326. Thus, unfiltered fluid from the engine flows into inlet opening 322 and then through orifices 326 to contact filter media 220. After passing through filter media 220, the fluid then flows through a substantially annular volume 500 (FIG. 5) defined between the filter media 220 and the interior surface of the housing. The filtered flow then exits back to the internal combustion engine via outlet openings 310.

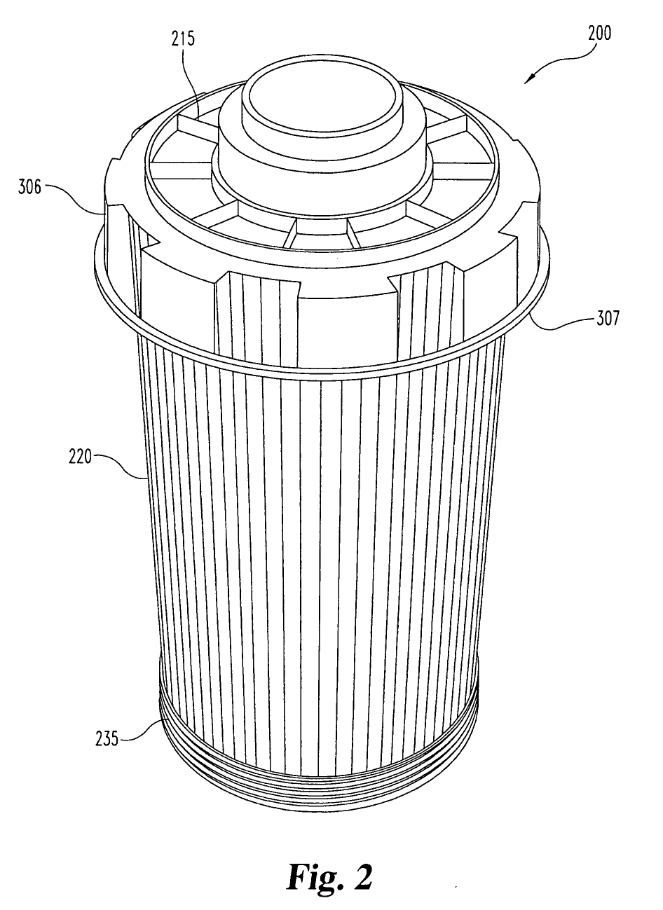

With reference to FIGS. 1-2, the filter cartridge 200 has a dome end endplate 235 with a top surface 332 connected to filter media 220. Dome end endplate 235 has a side wall 334 that extends away from the head end 210 to bottom surface 336. Dome end endplate 235 includes means for mating with the filter housing. In one embodiment of the present invention, the means for mating comprises external threading 340 on side wall 334 of dome end endplate 235.

With references to FIGS. 4-5, various attributes of filter housing 400 and its interconnection with filter cartridge 200 are illustrated. Filter housing 400 has a side wall 420 extending between an open head end 410 and a substantially closed dome end 430. Side wall 420 has an interior surface 424 and an exterior surface 426. At head end 410 the exterior surface 426 preferably defines external threading 430 at or substantially adjacent to the head end 410. External threading 430 corresponds to internal threading on a head mount or other mechanism (not illustrated) that attaches the housing and cartridge to the engine and provides the flow of unfiltered fluid from the engine and the flow of filtered fluid back to the engine. The exterior surface 425 at head end 410 preferably also includes a stop 432 to halt further insertion of the threading 430 into the mount, and also preferably includes a seal 434.

In one refinement, the head end endplate 215 of filter cartridge 200 may be press-fit into contact with side wall 420 of housing 400 at head end 410. In another refinement the interior surface 424 might include a plurality of ribs defined therein (not illustrated) to inhibit axial movement of the head end endplate 215 past a certain point.

Positioned substantially adjacent to the dome end 430 the interior surface 424 of housing 430 includes means for engaging the cartridge 440. In one form the means for engaging the cartridge 440 mates with the means for mating 340. As illustrated in FIG. 5, in one embodiment of the invention the means for engaging 440 is internal threading that corresponds to the external threading 340 of one embodiment of the dome end means for mating of cartridge 200.

As illustrated in FIG. 4, in one embodiment the substantially closed dome end 430 includes one or more openings or passages such as might be preferred for a drain outlet 432 as well as perhaps a sensor port 434. In the cross-sectional view of FIG. 5 the drain outlet 432 and sensor port 434 are omitted, however it is understood that these element are preferably, but not necessarily, present in embodiments of the present invention.

Thus, in the illustrated embodiment, the dome end endplate of the filter cartridge is in threaded engagement substantially adjacent the dome end of the filter housing. That is to say, the filter housing may have a means for engaging the filter cartridge that includes internal threading. The dome end endplate of the filter cartridge would then include means for mating with the housing that includes corresponding external threading. Alternatively, the housing might include external threading, and the filter cartridge include internal threading. As illustrated in FIGS. 4-5, the inner surface of the housing substantially adjacent to the dome end includes internal threading corresponding to external threading that is preferably around the perimeter or circumference of the dome end endplate of the filter cartridge.

A number of variations on the illustrated embodiments are contemplated as within the scope of the invention. As one example, the housing might include an annular collar with external threading mating to internal threading present, for example, on an axially extending rim of dome end endplate of the filter cartridge. Alternatively, the housing might define a short post extending up from the dome end toward the head end, preferably centrally located, with external threading that mates with corresponding internal threading on the cartridge.

In another embodiment the dome end endplate of the filter cartridge has a bayonet connection with the dome end of the filter housing. That is to say, the filter housing may have a means for engaging the filter cartridge that includes a plurality of openings. The dome end endplate of the filter cartridge would then include means for mating with the housing that includes a plurality of corresponding pins or projections that play in and out of the openings in the housing, thus serving to connect or disconnect the cartridge from the housing. In one refinement the housing defines a plurality of openings and the dome end endplate of the cartridge includes pins defined by an intermittent outer annular section of slightly greater diameter, the pins extending circumferentially and being able to rotate into the openings in the housing. Alternatively, the openings might be on the cartridge and the pins on the housing.

It should be understood that as used herein the term substantially adjacent to an end contemplates as within the scope of the invention that something might be the end, immediately next to the end, or might be slight spaced apart from the end. For example, the internal threading of the housing might be spaced apart slightly from the dome end to create a gap on that end through which fluid might flow through openings such as the drain outlet.

One embodiment of the present invention relates generally to a filter cartridge and a filter housing with a unique attachment point. That attachment point is preferably positioned to provide support at or near the point of the largest amount of vibrational amplitude. Thus, the positioning of the filter housing's means for engaging and the filter cartridge's means for mating is preferably selected to be at or near the point of the largest amount of vibrational amplitude (generally substantially adjacent the dome end).

It should be understood that it is contemplated as within the scope of the invention that the embodiments of the present invention, particularly an attachment point substantially adjacent the dome end, might find application in existing commercial products. In particular, such commercial products include, but are not limited to, the Mach 2 filter apparatus sold by Cummins Filtration (previously known as Fleetguard Inc.). Thus, variation of the attachment point might include that of the various commercial embodiments of the filter cartridge and filter housing of the Mach 2 filter. Such commercial embodiments include those that are preferably incinerable (substantially constructed of plastic), with or without a nutplate, and other variations known to those of skill in the art.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a filter cartridge including a filter media connected to and extending between a dome end endplate and a head end endplate;
a filter housing extending between a substantially open head end and a substantially closed dome end; and
the housing has an interior surface including means for engaging the filter cartridge positioned substantially adjacent the dome end, wherein the dome end endplate including means for mating to the housing to secure the dome end endplate to the housing substantially adjacent to the dome end of the housing.

2. The apparatus of claim 1, wherein the means for engaging the filter cartridge comprises threading.

3. The apparatus of claim 2, wherein the threading is adjacent the dome end of the housing.

4. The apparatus of claim 2, wherein the threading is internal threading.

5. The apparatus of claim 4, wherein the means for mating to the housing is external threading extending around at least a portion of a perimeter of the dome end endplate.

6. The apparatus of claim 1, wherein the means for mating to the housing comprises a plurality of pins extending from the dome end endplate of the cartridge, and wherein the means for engaging the cartridge comprises a plurality of openings that receive the pins of the cartridge.

7. The apparatus of claim 1, wherein the apparatus is a centrifugal filter, and wherein the means for engaging the filter cartridge and the means for mating to the housing are positioned substantially adjacent to a point of the largest amplitude vibration of the apparatus.

8. The apparatus of claim 2, wherein the housing has an external surface that defines external threading substantially adjacent to the head end.

9. The apparatus of claim 1, wherein the head end endplate defines an inlet opening for an unfiltered fluid.

10. The apparatus of claim 9, wherein the filter cartridge further includes a substantially hollow member with a sidewall extending from an open first end connected to the inlet opening toward a closed second end, the second end being closer to the dome end endplate than the head end endplate, the sidewall defining a plurality of openings between the first end and the second end.

11. The apparatus of claim 10, wherein the head end endplate includes a radially outermost portion that extends axially toward the dome end endplate and overlaps a portion of the filter media.

12. The apparatus of claim 10, wherein the head end endplate includes a radially outermost portion that defines a plurality of outlet openings.

13. A replaceable cartridge for use with a filter housing having a substantially closed dome end and a head end, the replaceable cartridge comprising:
a filter media connected to and extending between a head end endplate and a dome end endplate, the dome end endplate including threading to secure the dome end endplate within the housing substantially adjacent to the dome end of the housing.

14. The apparatus of claim 13, wherein the head end endplate defines an inlet opening for an unfiltered fluid, and wherein the cartridge further includes a tube with a sidewall extending from an open first end connected to the inlet opening toward a closed second end, the second end being closer to the dome end endplate than the head end endplate, the sidewall defining a plurality of openings between the first end and the second end.

15. The apparatus of claim 14, wherein the head end endplate includes a radially outermost portion that extends axially toward the dome end endplate and overlaps a portion of the filter media, and wherein the radially outermost portion defines a plurality of outlet openings.

16. A replaceable cartridge for use with a filter housing having a substantially closed dome end and a head end, the cartridge comprising:
a filter media connected to and extending between a head end endplate and a dome end endplate, the dome end endplate including means for mating with the filter housing.

17. The cartridge of claim 16, wherein the means for mating to the housing is external threading extending around at least a portion of a perimeter of the dome end endplate of the cartridge.

18. The cartridge of claim 17, wherein the means for mating to the housing is a portion of a bayonet connection between the cartridge and the housing.

19. The apparatus of claim 16, wherein the head end endplate defines an inlet opening for an unfiltered fluid, and wherein the cartridge further includes a tube with a sidewall extending from an open first end connected to the inlet opening toward a closed second end, the second end being closer to the dome end endplate than the head end endplate, the sidewall defining a plurality of openings between the first end and the second end.

20. The apparatus of claim 19, wherein the head end endplate includes a radially outermost portion that extends axially toward the dome end endplate and overlaps a portion of the filter media, and wherein the radially outermost portion defines a plurality of outlet openings.
